(19) United States
(12) Patent Application Publication
(10) Pub. No.: US 2016/0140830 A1
(43) Pub. Date: May 19, 2016

(54) SYSTEM AND METHOD FOR TRACKING AND REDUCING HUMAN-TO-HUMAN TRANSMISSION OF INFECTIOUS PATHOGENS

(71) Applicant: James HATHORN, Durham, NC (US)

(72) Inventor: James HATHORN, Durham, NC (US)

(21) Appl. No.: 14/941,133

(22) Filed: Nov. 13, 2015

Related U.S. Application Data
(60) Provisional application No. 62/079,835, filed on Nov. 14, 2014.

(51) Int. Cl. G08B 21/18

(52) U.S. Cl. CPC G08B 21/18

(57) ABSTRACT

A system, apparatus, method, and computer program product for encouraging prevention of hand-to-face contact are provided. The system includes a hand module configured to be worn near a hand of at least one user, a face module configured to be worn in an area at chest level or above for at least one user, and a processor configured to generate an alert when the hand module comes within a predefined range of the face module.

### CROSS-REFERENCE TO RELATED APPLICATION

This application claims the benefit of U.S. Provisional Application Ser. No. 62/079,835, entitled “SYSTEM AND METHOD FOR TRACKING AND REDUCING HUMAN-TO-HUMAN TRANSMISSION OF INFECTIOUS PATHOGENS” and filed on Nov. 14, 2014, which is expressly incorporated by reference herein in its entirety.

### FIELD

Aspects of the present invention relate to a system and method designed to help prevent the spread of one or more infectious agents in a human population.

### BACKGROUND

Despite phenomenal technological advancements over the last century, infectious diseases continue to exact a tremendous toll on the human population. The common cold is the most frequently cited reason for missed time at work or school; influenza kills hundreds of thousands on an annual basis, and new threats continue to emerge, as evidenced by the recent outbreak of Ebola Hemorrhagic Fever. Vaccination is the primary and defense against viruses but is imperfect. Delayed development (vaccines typically take 3-12 months to develop after a pathogen has been identified) and access limitations underscore the importance of transmission prevention strategies in combating the spread of the disease. Additionally, quick and effective identification and notification of individuals who may have come in contact with an infected person or specific pathogen is also necessary.

### SUMMARY

A very common person-to-person pathogen transmission route occurs when a healthy person's hands become contaminated with pathogens from an infected person or a contaminated object. When the healthy person subsequently touches his or her face with the contaminated hand, the pathogen is absorbed through the mouth, nose, or eyes and infection occurs. Effective hand washing and minimizing face-hand contact (especially when the potential for hand contamination exists) are two of the best defenses against this transmission route.

Aspects as presented herein incorporate wireless, wearable technologies designed to minimize inadvertent face-hand contact and encourage effective hand washing. Furthermore, additional aspects of the invention track each occurrence of hand-washing and inadvertent (and hopefully averted) face-hand contact. The resulting data may be transmitted via software on a computer or mobile device, for example, which identifies the time and location from which the signal originated. This information may then stored in memory, either on the local device or on a secured server to which a connection is made through the internet, or both. In addition, the software may also capture and store and/or transmit to a secured server the person's GPS location on a set interval basis (e.g. in a range of approximately every 1-30 minutes, e.g., in a range of approximately every 15 minutes) in effect creating a personal timeline of when and where the person has been.

Aspects of the invention may also include a secured web portal through which governments, non-governmental organizations, healthcare facilities and providers, infected individuals, and others may input, upload, or otherwise submit the time and location history for the period during which a de-identified individual, thought to be a disease vector, was capable of infecting others. Once uploaded to the server, this data may then be matched against the time, location, face-touch, and hand-washing information supplied by individual users of the wearable prevention technology. Should a time-location match be found between a user and a suspected vector, the system may alert the user and assess the risk that the user was infected using hand hygiene, face-hand proximity/contact, and other additional information.

Additional advantages and novel features relating to aspects of the present invention will be set forth in part in the description that follows, and in part will become more apparent to those skilled in the art upon examination of the following or upon learning by practice thereof.

### BRIEF DESCRIPTION OF THE DRAWINGS

FIG. 1 is a schematic drawing of hand and face modules operating in conjunction to reduce inadvertent face-hand contact in accordance with aspects of the present invention.

FIG. 2 is a schematic drawing of example hand and face modules operating in conjunction with software and memory on a computer in accordance with aspects of the present invention.

FIG. 3 is a schematic drawing of an example system that can be used to identify potential pathogen exposures and determine the risk that an individual has contracted the pathogen in accordance with aspects of the present invention.

FIG. 4 illustrates example aspects that may be analyzed in accordance with aspects of the present invention.

FIG. 5 is a perspective view of an example hand module in the form of a bracelet in accordance with aspects of the present invention.

FIG. 6 is a perspective view of an example hand module in the form of a ring in accordance with aspects of the present invention.

FIG. 7 is a perspective view of an example hand module in the form of a finger wrap in accordance with aspects of the present invention.

FIG. 8 is a perspective view and illustration of an example application of an adhesive hand module to the hand in accordance with aspects of the present invention.

FIG. 9 is a perspective view of an example hand module embedded into a glove worn on the hand in accordance with aspects of the present invention.

FIG. 10 is a perspective view of an example small, shaped face module and an example clip into which the face module may be inserted, which the user may attach to his body or clothing in close proximity to the face in accordance with aspects of the present invention.

FIG. 11 is a perspective view of an example face module being worn on a shirt collar and attached to a stethoscope in accordance with aspects of the present invention.

FIG. 12 is a perspective view of an example face module that attaches directly to the skin using adhesive; in the illustration, the face module is positioned on the back of the user's neck in accordance with aspects of the present invention.

FIG. 13 presents an example system diagram of various hardware components and other features, for use in accordance with aspects of the present invention; and

FIG. 14 is a block diagram of various example system components, in accordance with aspects of the present invention.

FIG. 15 is a block diagram of various example system components of a hand module, in accordance with aspects of the present invention.

FIG. 16 is a block diagram of various example system components of a face module, in accordance with aspects of the present invention.

### DETAILED DESCRIPTION

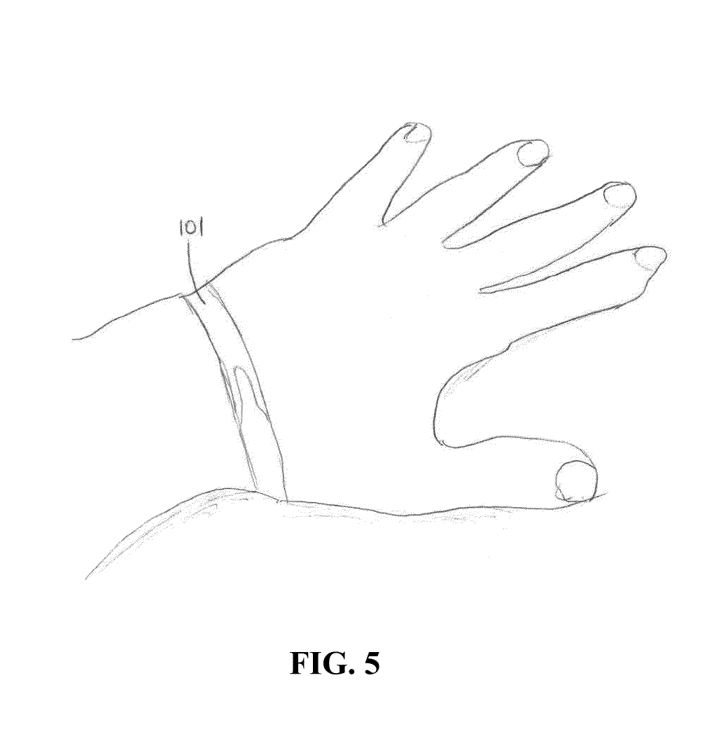

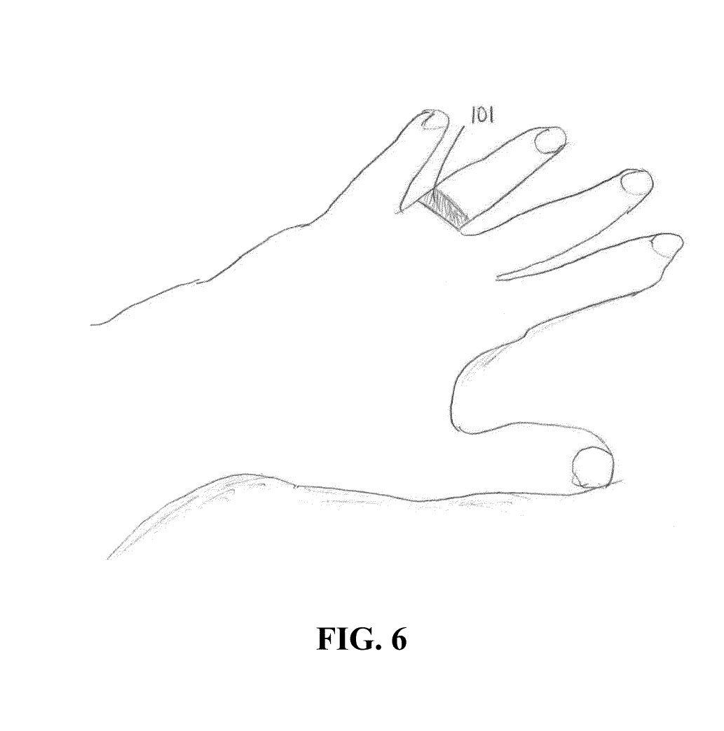

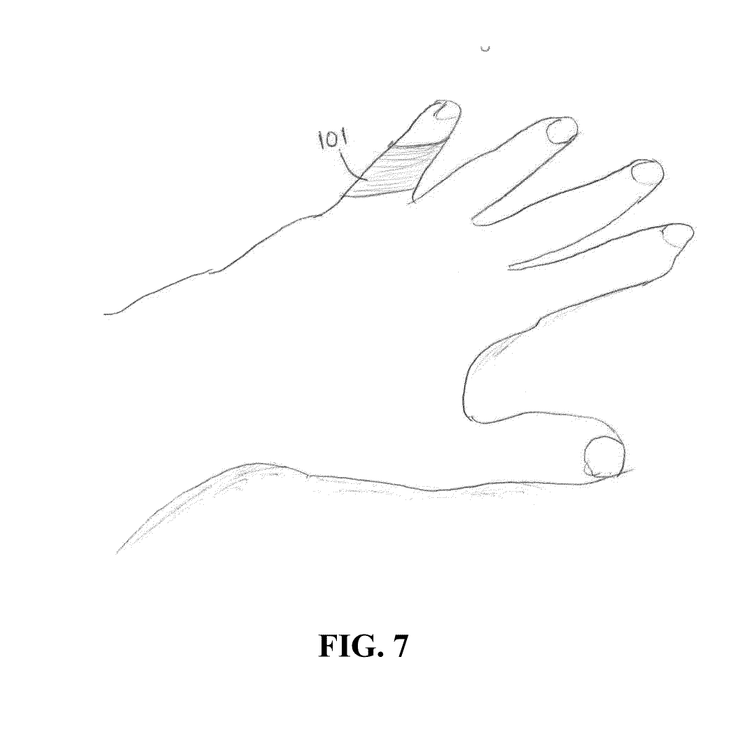

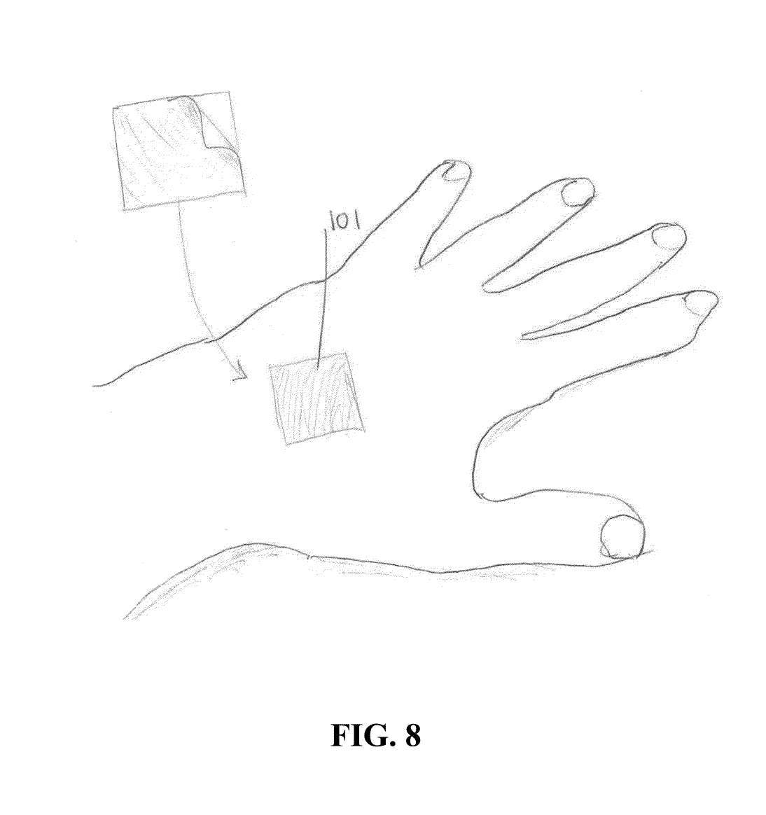

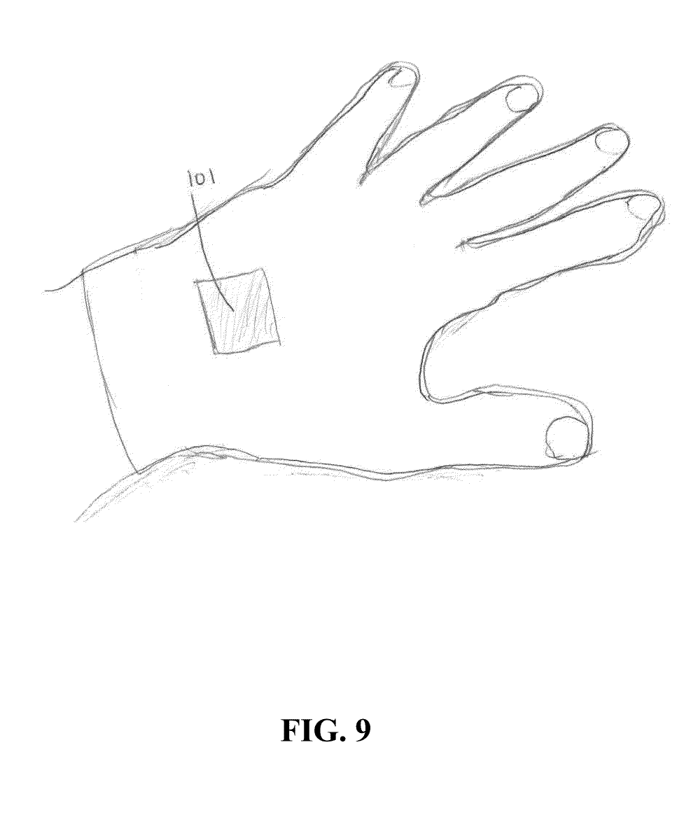

One aspect of the invention includes the placement of modules 101, 103 capable of being attached to or placed on each hand or in close proximity to each hand. Among other components, the hand module 101 may comprise a transceiver, a transmitter and a receiver, and/or a microcontroller. Each hand module 101 may be integrated into items commonly worn on or about the hand including, e.g., rings, bracelets, watches, and gloves, among other such items. Additionally, the hand module 101 may be configured to be applied to the hand, e.g., as adhesive finger sleeves or stickers that adhere directly to the skin. See FIGS. 5, 6, 7, and 8. Modules 101 may be embedded, for example, in disposable hand protection equipment commonly used in healthcare settings such as latex (or latex-free) gloves. See, for example, FIG. 9. The modules may be either disposable or re-usable. Both disposable and re-usable modules 101 may be configured, for example, to be capable of withstanding frequent, vigorous hand-washing without becoming unattached or suffering any performance issues. If re-usable, the modules 101 may also be capable of undergoing sterilization through one or more of the procedures commonly used in current healthcare settings. The modules 101 may be either passive or active. Passive modules generally may, for example, be configured so as to require no power source, and are not likely to serve as the node in the network that will transmit data to a computer for storage and analysis.

Hand modules 101 that are active may incorporate a power source, as well as additional sensors, such as accelerometers and gyroscopes to measure hand motion and orientation. Active hand modules may also be designed, for example, to transmit and/or receive information to and from a computer capable of storing and analyzing data. Such transmission may be achieved, for example, wirelessly or via a direct connection between the computer and the hand module. Also, active hand modules may be designed to transmit and/or receive signals from passive face modules. Active hand modules may also incorporate various other features and functionalities, such as use LED lights, auditory sounds, vibration, temperature, and other commonly employed sensory stimuli that when triggered communicate information to the user of the device.

The system may further include a face module 103. Similar to the hand modules, the face modules 103 may comprise, for example, a transceiver, transmitter and receiver, and/or a microcontroller. The face module 103 may also be active or passive, similar to the description of the hand module 101. Active face modules may incorporate a power source and may transmit and/or receive data to and from a computer capable of storing and analyzing data. Such transmission and/or reception may be wireless or via a direct connection between the computer and the face module 103. The face module 103 may be configured to be either re-usable or disposable. For example, a re-usable face module may be configured to be capable of undergoing sterilization through methods commonly used in healthcare settings.

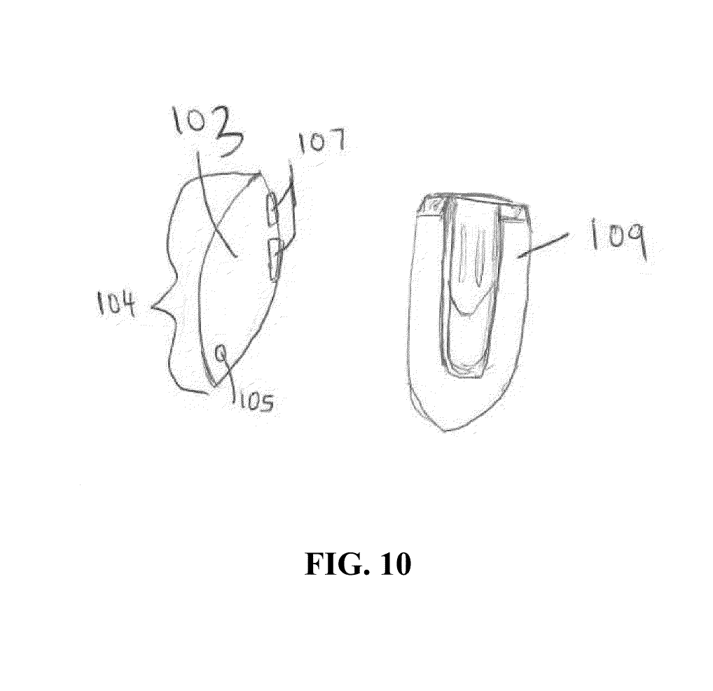

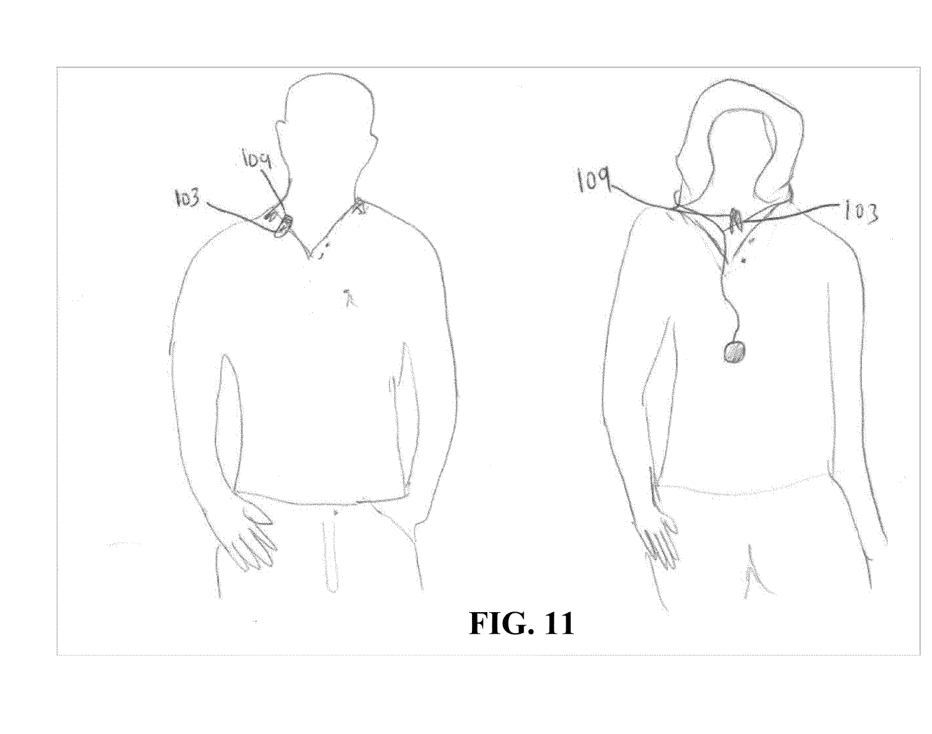

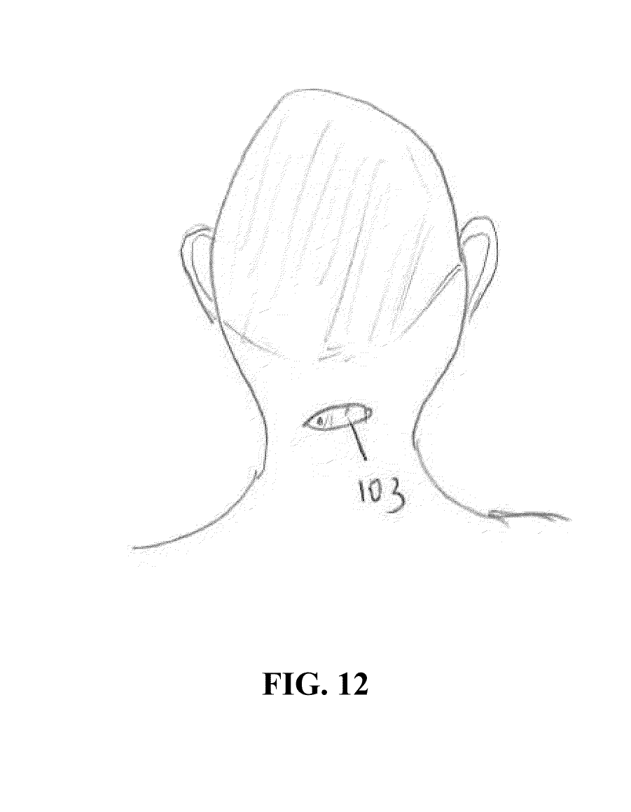

The face module 103 may be worn by the user in relatively close proximity to the face. The face module 103 may be configured to be worn approximately on the chest or should area of a user. For example, the face module may be configured as a pin, button, or lapel worn in clothing on or about the chest and shoulders, among other designs. It may be configured to appear similar to jewelry, such as a necklace or earrings. It also may comprise a small plastic shape 104 with an LED indicator light 105 and a power on/option buttons 107. The device may attach directly to clothing or skin, or fit into a clip 109 that may be fastened to clothing or to a stethoscope. See, for example, FIGS. 10, 11, and 12. As with the hand module 101, the face module 103 may be configured to comprise an adhesive that adheres directly to the skin.

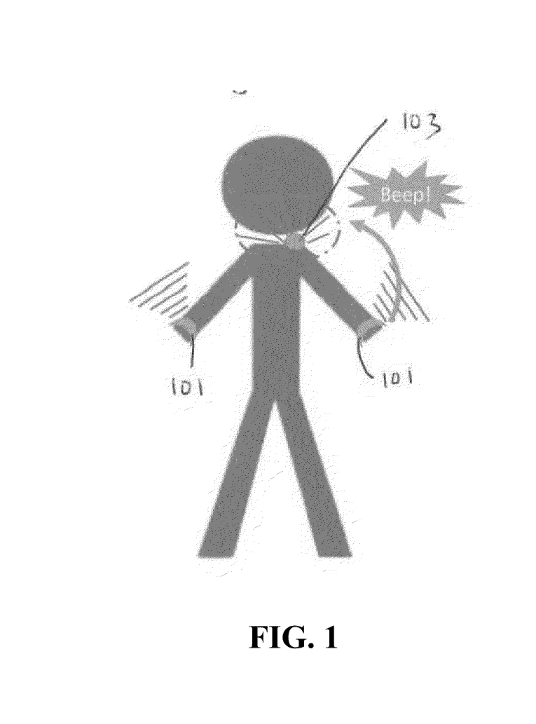

The face 103 and hand modules 101 may operate in conjunction so as to encourage a user to minimize the occurrence of inadvertent face-hand contact. See, e.g., FIG. 1. At least one of either i) the face module 101 or ii) the hand modules 103 may be active and equipped with a power source. Furthermore, at least one of either i) the face module 101 or ii) the hand modules 103 may be equipped with aspects capable of sensing proximity between each of the hand modules 101 and the face module 103. Additionally, at least one of either i) the face module 103 or ii) the hand modules 101 may be equipped with a stimulatory functionality capable of alerting the user in a timely manner when the proximity between any hand module and the face module reaches a certain threshold.

The hand modules 101 and face module 103 may be designed to reduce inadvertent hand-face contact by alerting the user when one or both hands come within a designated distance of the face. However, to allow for desired hand-face contact, one or more of the modules may be equipped with an override mechanism that, once activated by the user, permits the hand 101 and face 103 modules to be within close proximity of one another (without triggering an alert) for a set period of time. At the conclusion of this time period, the modules may automatically return to normal functionality. The override function may be useful for example, in circumstances in which hand-face contact is i) acknowledged by the device user and ii) desired and/or necessary. Examples of such situations include eating meals and performing personal hygiene activities.

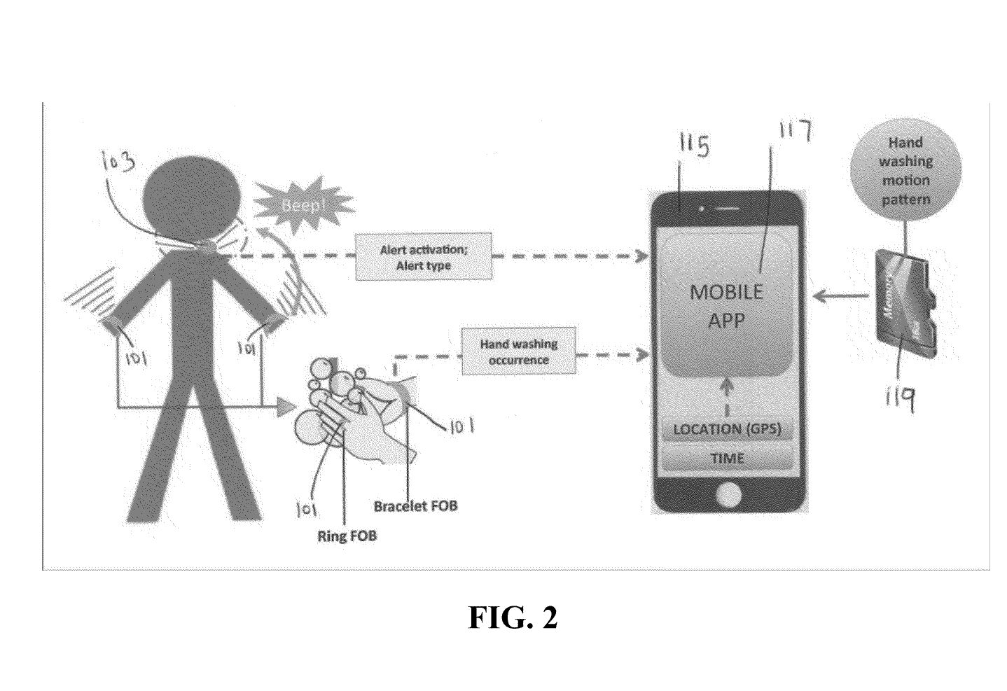

The hand modules 101 may also be equipped with sensors that help promote effective and consistent hand washing. These sensors may include one or more accelerometers and/or gyroscopes to capture hand motion and orientation and one or more thermometers and/or moisture sensors to identify changes in temperature and the presence of moisture. When hand modules equipped with hand washing sensors are in communication with a computer 115, for example, they may be used during a learning phase in conjunction with software 117 on the computer 115. During the learning phase, the user may wash his or her hands one or several times with the hand modules 101 engaged, and the modules 101 will transmit data to the software 117 on the computer 115 for specific analysis and storage in memory 119. The stored hand washing data may then be used by the software 117 to generate an algorithm and identify additional instances of hand washing by the user in the future. See, e.g., FIG. 2. Additional information about each hand washing occurrence, such as duration of washing and water temperature, may also be captured using the sensors. The hand modules 101 may also include features that remind users to wash their hands at specified intervals or after performing certain tasks. Specific tasks may be identified by data generated by the modules and transmitted and analyzed by software 117 on a computer 115, for example, or by geospatial detection of the hand modules by a computer or network.

Other components of the system may include one or more software applications 117 that reside on a computer 115 remote from the hand module 101 and the face module 103, such as a computer generally found in close proximity to the user, such as a mobile smartphone or other type of personal computer. The computer program application 117 may track and store instances of specific data transmissions from the modules 101, 103, such as a hand-face contact alert having been triggered or a hand washing that exceeded a specified time interval, alongside time and location information also captured by the computer/mobile device 115. The system may then be used to identify patterns and provide analyses to the user, for example, to help improve hand hygiene and identify times and locations at which they are particularly susceptible to contamination via hand-face contact. See, e.g., FIG. 2. The system may also be employed to create a general time and place history for the user by continuously or intermittently, for example, capturing location information on a set interval. The set interval may be within the a range of approximately a few seconds to an hour, e.g., within an approximate range of one minute to 30 minutes, such as every 15 minutes.

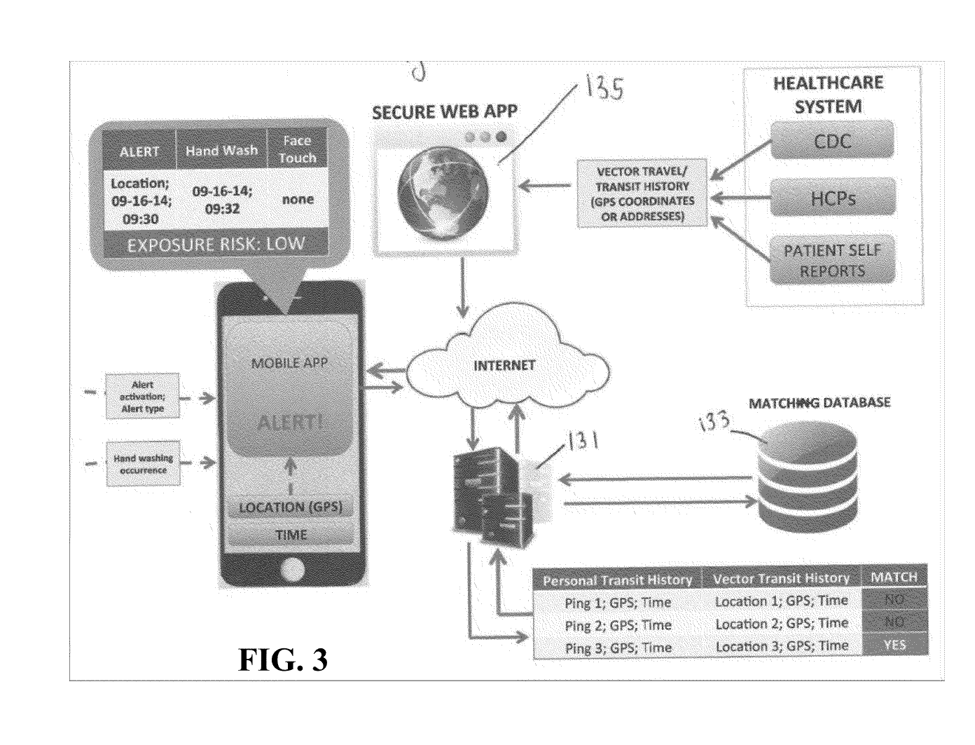

The system may also include a secure web server 131 and data repository 133 (e.g., a database) into which data from users' local computers 115 may be transmitted and stored. This data may include information captured by the system on users' local computer or mobile telephone (e.g., computer 115) including instances of hand-face contact and hand-washing, and additional details including time and location of each occurrence. A user's general time and place history may also be transferred to the secured web server 131 and stored in the database 133. See, e.g., FIG. 3.

Verified third parties may also be permitted to submit information through a web portal 135, for example, to the secured web server 131. These third parties may include, for example, organizations with valid information regarding potential exposures to pathogens. For example, the Center for Disease Control may submit the travel history of an infected patient during the period in which the patient was known to be capable of infecting others. Software operating on the server and a database may take this submitted information and use it to identify any system users that may have been exposed to the pathogen. One example may include identifying users whose known time and location matched the infected patient, within a particular time and space threshold. In addition to identifying users at risk of exposure, the system may further evaluate users' risk by determining whether or not hand washing and hand-face contact occurred. See, e.g., FIG. 3. This information may be incorporated into, for example, an algorithm that calculates the user's personal risk of pathogen exposure.

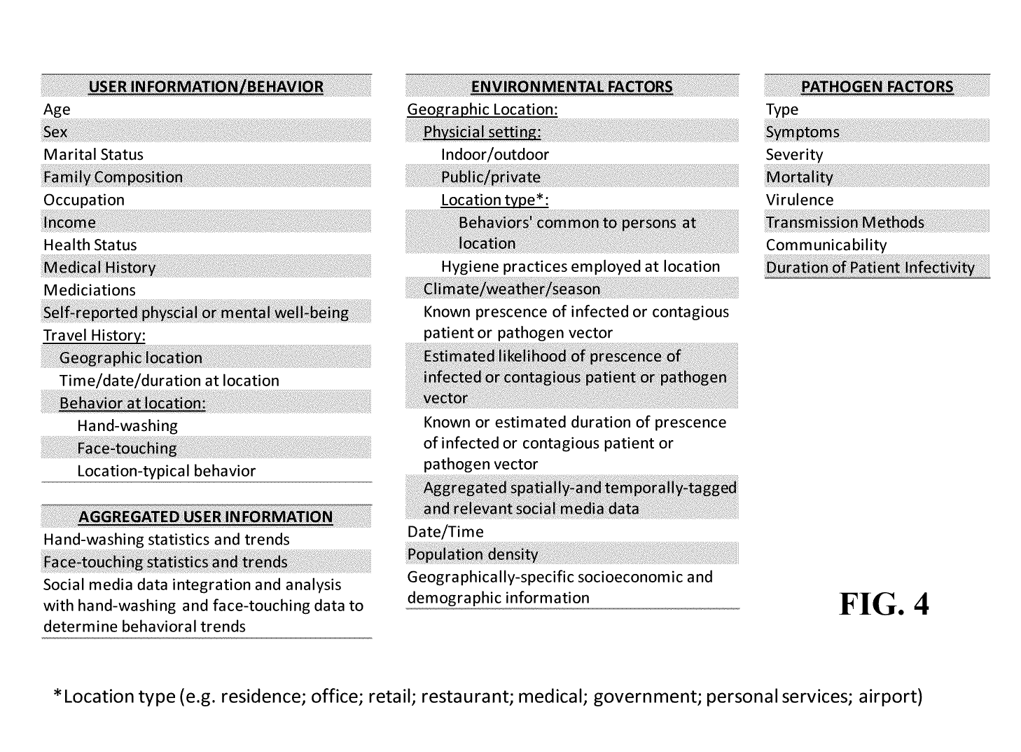

For example, the analysis and/or calculation may include a comparison of a single users' hand-washing and face-touching frequency relative to the aggregated mean frequency of these behaviors among all users in the system. A higher risk could be assessed for users that wash their hands at a frequency below the majority of system users and/or touch their face at a frequency above the majority of system users. Hand washing and/or hand to face contact may be among a number of factors that are analyzed in order to generate a potential risk of infection for the user. A comparison of a user's ratio of hand washing to face touching could also be compared against aggregated mean ratios representative of all system users, or system users that fall within a population demographic defined by one or several of the USER INFORMATION/BEHAVIOR factors listed in FIG. 4. The algorithm may also leverage stored or supplied temporal and spatial travel history data of individuals known or suspected to have been capable of transmitting a pathogen to others. The calculation may be triggered when a match is identified between a users' temporal and spatial travel history and the stored travel history of a known or suspected contagious patient, meaning that a user was present at a location during or within a specified period the time at which a contagious patient (or other infectious disease contraction threat) was also present, establishing a risk of exposure for the user. Once this exposure threshold trigger is met, the calculation may include a substantial number of additional factors to predict the likelihood that the user is or will become infected as a result of his or her exposure. Several types of factors, including individual and aggregated user information, environmental factors, and pathogen-specific factors, may be incorporated into the algorithm to assess exposure and transmission risk.

For example, a higher exposure and transmission risk may be indicated where a user and a known infectious patient spend overlapping or adjacent time periods in a location known to be a small fitness club. Additional factors beyond location may be included in the assessment such that a higher risk is assessed when the infected patient is infected with a pathogen known to be easily spread through surface contact, and/or when the user fails to wash their hands until several hours after leaving the location.

As another example, a higher exposure and transmission risk may be assessed where a user spends several hours without washing their hands in a public space such as a coffee shop. Additional factors may be included in the assessment such that a higher risk is predicted for the coffee shop being in a densely populated portion of a city And/or the weather being cold enough that it forces the closure of the coffee shop's sidewalk seating, and/or the coffee shop is in an geographic area in which a high concentration of infected persons is suspected. The identification of geographic areas in which a high concentration of infected persons is suspected may include, for example, the analysis of stored or incorporated, temporally and geo-spatially relevant aggregated social media data such as Twitter tweets indicating the person ‘posting’ the information is feeling poorly or suspects or confirms that they or someone that they know is ill.

The system may also be used by the user to assess risk on a prospective basis based on travel and behavioral plans. For example, if a user plan to travel through an airport which was calculated to confer additional risk, the system may activate a series of hand-washing reminders to promote more frequently hand washing and reduce risk of transmission. The system may also deliver alerts to the user's local computer so that they may respond accordingly, among other purposes. See, e.g., FIG. 3.

Having identified users at risk of exposure, the system may serve as network for the provision of specific, potentially sensitive information and may additionally as provide a resource for contact tracing activities, for example, to identify additional persons that may have been exposed.

Several aspects of the system have been presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

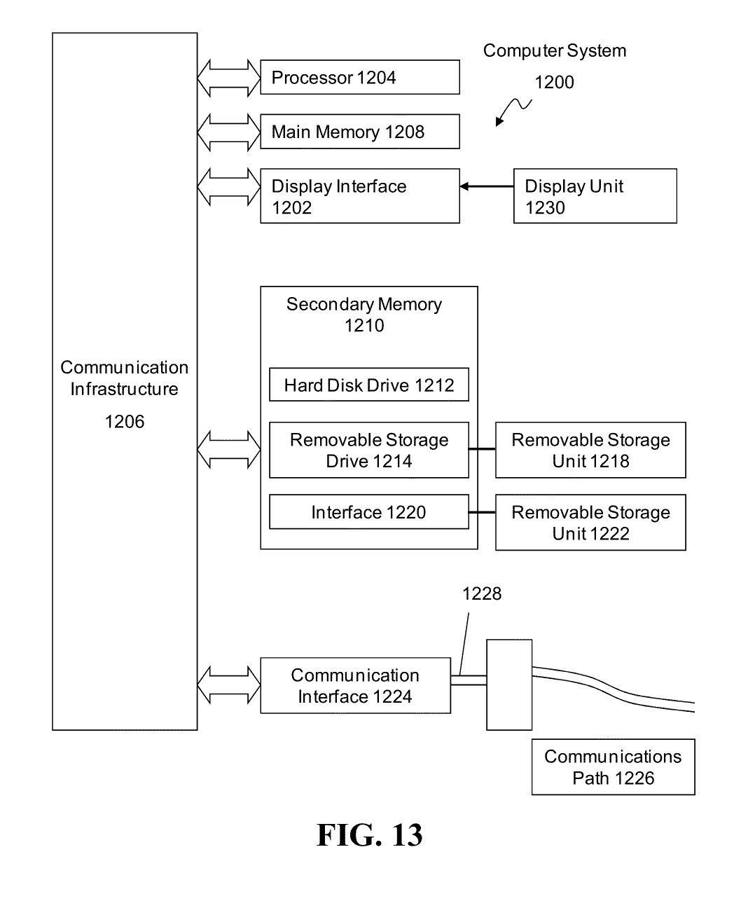

FIG. 13 presents an example system diagram of various hardware components and other features, for use in accordance with aspects presented herein. The aspects may be implemented using hardware, software, or a combination thereof and may be implemented in one or more computer systems or other processing systems. In one example, the aspects may include one or more computer systems capable of carrying out the functionality described herein. An example of such a computer system 1200 is shown in FIG. 13.

Computer system 1200 includes one or more processors, such as processor 1204. The processor 1204 is connected to a communication infrastructure 1206 (e.g., a communications bus, cross-over bar, or network). Various software aspects are described in terms of this example computer system. After reading this description, it will become apparent to a person skilled in the relevant art(s) how to implement the aspects presented herein using other computer systems and/or architectures.

Computer system 1200 can include a display interface 1202 that forwards graphics, text, and other data from the communication infrastructure 1206 (or from a frame buffer not shown) for display on a display unit 1230. Computer system 1200 also includes a main memory 1208, preferably random access memory (RAM), and may also include a secondary memory 1210. The secondary memory 1210 may include, for example, a hard disk drive 1212 and/or a removable storage drive 1214, representing a floppy disk drive, a magnetic tape drive, an optical disk drive, etc. The removable storage drive 1214 reads from and/or writes to a removable storage unit 1218 in a well-known manner. Removable storage unit 1218, represents a floppy disk, magnetic tape, optical disk, etc., which is read by and written to removable storage drive 1214. As will be appreciated, the removable storage unit 1218 includes a computer usable storage medium having stored therein computer software and/or data.

In alternative aspects, secondary memory 1210 may include other similar devices for allowing computer programs or other instructions to be loaded into computer system 1200. Such devices may include, for example, a removable storage unit 1222 and an interface 1220. Examples of such may include a program cartridge and cartridge interface (such as that found in video game devices), a removable memory chip (such as an erasable programmable read only memory (EPROM), or programmable read only memory (PROM)) and associated socket, and other removable storage units 1222 and interfaces 1220, which allow software and data to be transferred from the removable storage unit 1222 to computer system 1200.

Computer system 1200 may also include a communications interface 1224. Communications interface 1224 allows software and data to be transferred between computer system 1200 and external devices. Examples of communications interface 1224 may include a modem, a network interface (such as an Ethernet card), a communications port, a Personal Computer Memory Card International Association (PCMCIA) slot and card, etc. Software and data transferred via communications interface 1224 are in the form of signals 1228, which may be electronic, electromagnetic, optical or other signals capable of being received by communications interface 1224. These signals 1228 are provided to communications interface 1224 via a communications path (e.g., channel) 1226. This path 1226 carries signals 1228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 1212, and signals 1228. These computer program products provide software to the computer system 1200. Aspects presented herein may include such computer program products.

Computer programs (also referred to as computer control logic) are stored in main memory 1208 and/or secondary memory 1210. Computer programs may also be received via communications interface 1224. Such computer programs, when executed, enable the computer system 1200 to perform the features presented herein, as discussed herein. In particular, the computer programs, when executed, enable the processor 1210 to perform the features presented herein. Accordingly, such computer programs represent controllers of the computer system 1200.

In aspects implemented using software, the software may be stored in a computer program product and loaded into computer system 1200 using removable storage drive 1214, hard drive 1212, or communications interface 1220. The control logic (software), when executed by the processor 1204, causes the processor 1204 to perform the functions as described herein. In another example, aspects may be implemented primarily in hardware using, for example, hardware components, such as application specific integrated circuits (ASICs). Implementation of the hardware state machine so as to perform the functions described herein will be apparent to persons skilled in the relevant art(s).

In yet another example, aspects presented herein may be implemented using a combination of both hardware and software.

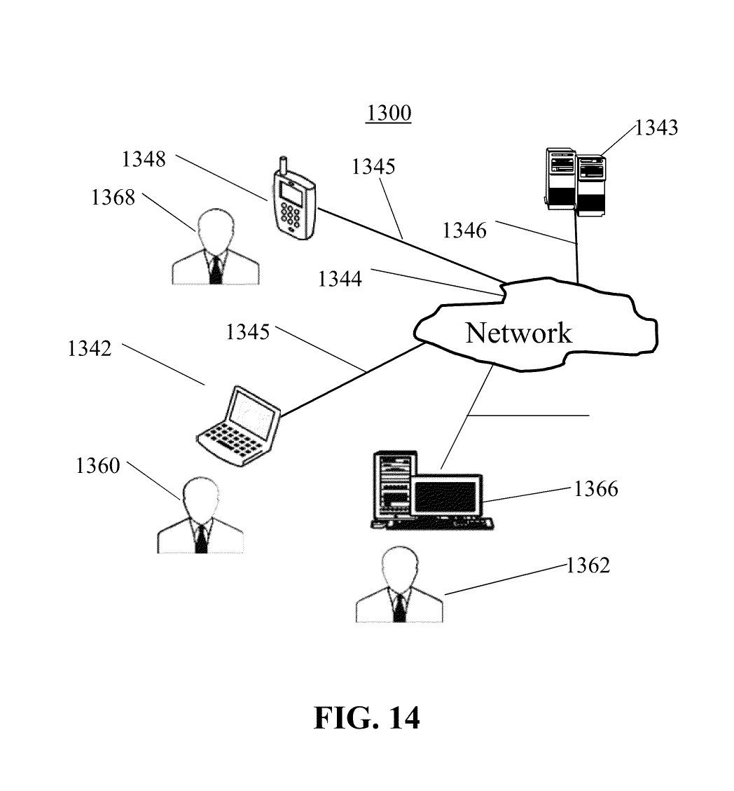

FIG. 14 is a block diagram of various example system components, in accordance with aspects presented herein. FIG. 14 shows a communication system 1300 usable in accordance with the present invention. The communication system 1300 includes one or more accessors 1360, 1362, 1368 (also referred to interchangeably herein as one or more “users”) and one or more terminals 1342, 1366, and 1345. In one aspect, data for use in accordance aspects presented herein, for example, input and/or accessed by accessors 1360, 1364 via terminals 1342, 1366, such as personal computers (PCs), minicomputers, mainframe computers, microcomputers, telephonic devices, or wireless devices, such as personal digital assistants (“PDAs”) or a hand-held wireless devices coupled to a server 1343, such as a PC, minicomputer, mainframe computer, microcomputer, or other device having a processor and a repository for data and/or connection to a repository for data, via, for example, a network 1344, such as the Internet or an intranet, and couplings 1345, 1346, 1364. The couplings 1345, 1346, 1364 include, for example, wired, wireless, or fiberoptic links. In another aspect, the method and system presented herein operate in a stand-alone environment, such as on a single terminal.

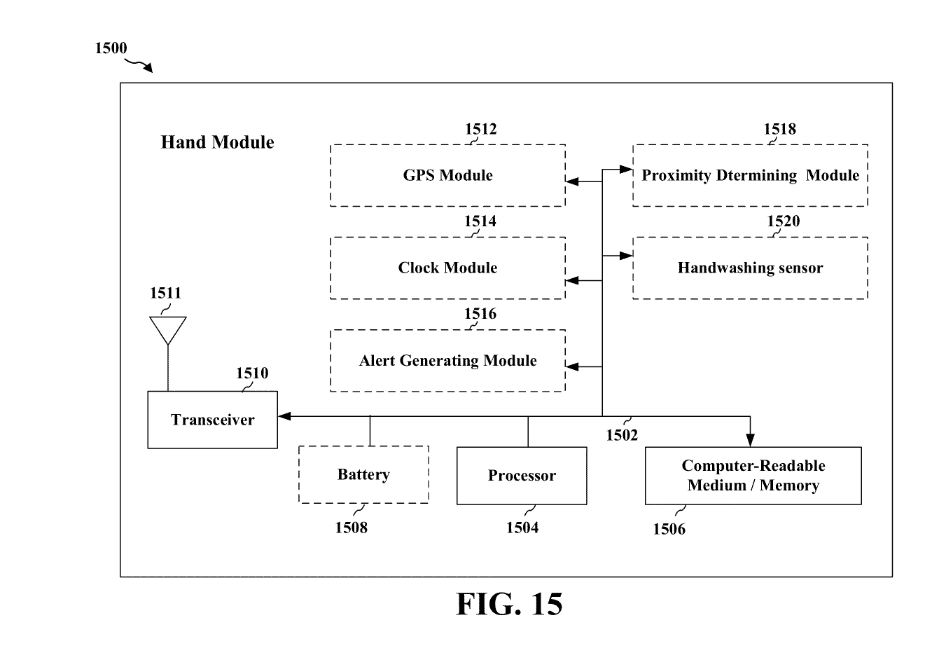

FIG. 15 illustrates a number of example system components that might be included in a hardware implementation of a hand module 1500 in accordance with aspects presented herein. The hand module 1500 may employ a processing system, which may be implemented with a bus architecture, represented generally by the bus 1502 that links together various circuits including one or more processors and/or hardware modules, represented by the processor 1504, the modules 1512, 1514, 1516, 1518, 1520, and the computer-readable medium/memory 1506. The bus 1502 may also link various other circuits.

The processing system may be coupled to a transceiver, a transmitter and/or a receiver 1510. The transceiver 1510 may be coupled to one or more antennas 1511. The transceiver 1510 provides a means for the hand module to communicate communicating with various other apparatus, such as the face module, a smart device, a remote computer, etc. over a transmission medium. The transceiver 1510 receives a signal from the one or more antennas 1511, extracts information from the received signal, and provides the extracted information to the processing system. In addition, the transceiver 1510 receives information from the processing system, and based on the received information, generates a signal to be applied to the one or more antennas 1511. The processing system further includes at least one of the modules 1512, 1514, 1516, 1518, and 1520. The modules may be software modules running in the processor 1504, resident/stored in the computer readable medium/memory 1506, one or more hardware modules coupled to the processor 1504, or some combination thereof.

GPS module 1512 may determine a geographic location of the hand module 1500. The determined location may be stored locally, e.g., in memory 1506 and/or may be transmitted to a user's computer via antenna 1511. Clock module 1514 may maintain an accurate clock so that a time may be associated with the location determined by the GPS module. This location and time may be used in order to determine whether the user may have come into proximity of an infectious person. Alert Generating Module 1516 may generate an alert when a certain condition is met or when an assessed risk is above a threshold. As discussed supra, the alert may be visual, auditory, vibration, etc. The alert may be generated for the user directly at the hand module and/or the alert generating module 1516 may cause an alert to be transmitted to a computer, smart device, etc. via transceiver 1510.

Proximity determining module 1518 may assess the proximity of a hand module to a face module. The assessed proximity may be used by the alert generating module 1516 in order to alert the user when the hand module comes within a predefined distance from the face module. Such an alert may be made in order to help the user avoid hand to face contact. Proximity may be determined to the face module worn by the user and/or to a face module worn by another person.

Handwashing sensor 1520 may detect conditions indicating that a user is washing their hands. For example, handwashing sensor 1520 may sense that a user's hands have come into contact with water. The number of instances of handwashing and/or a handwashing frequency may be stored in memory 1506 or transmitted via antenna 1511. A time determined using clock module 1514 may be associated with the indication of the instances of handwashing.

The hand module 1500 may further include a battery 1508 that provides power for the hand module.

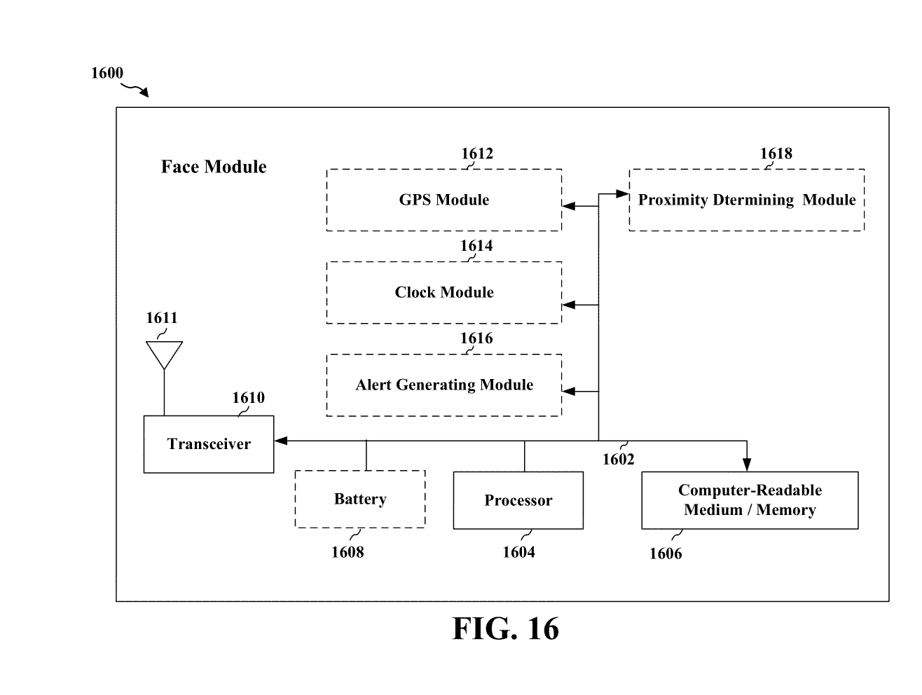

FIG. 16 illustrates example system components that may be included in a face module 1600. The face module 1600 may have components similar to the hand module in FIG. 15, with the exception of the handwashing module. Thus, face module 1600 may include a processing system having a bus 1602 connecting processor 1604, memory 1606, battery 1608, GPS module 1612, clock module 1614, alert generating module 1616, proximity determining module 1618, transceiver, transmitter or receiver. Transceiver 1610 may be connected to antenna 1611.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A system for encouraging prevention of hand-to-face contact, the system comprising:
a hand module configured to be worn near a hand of at least one user;
a face module configured to be worn in an area at chest level or above for at least one user; and
a processor configured to generate an alert when the hand module comes within a predefined range of the face module.

2. The system of claim 1, wherein at least one of the hand module or the face module comprises an active module having:
a communication component for transmitting information to and receiving information from a separate computer;
a power source; and
the processor.

3. The system of claim 2, wherein the other of the hand module or the face module comprises a passive module.

4. The system of claim 1, wherein the alert comprises at least one selected from a group consisting of an auditory alert, a visual alert, a vibration alert, and a temperature alert.

5. The system of claim 4, wherein the alert is generated by at least one selected from a group consisting of the hand module and the face module.

6. The system of claim 1, wherein the alert comprises a message transmitted to a terminal separate from the hand module and the face module.

7. The system of claim 1, wherein the system is configured to maintain a history of a time and a corresponding location of at least one user.

8. The system of claim 7, wherein the system is configured to receive time and location information regarding potentially contagious situations and to use the maintained history of the time and corresponding location of at least one user to determine whether the at least one user was within a range of a potentially contagious situation.

9. The system of claim 1, wherein the hand module further comprising:
a sensor configured to sense handwashing.

10. A method for encouraging the prevention of hand-to-face contact, the system comprising:
receiving information from at least one of a hand module configured to be worn on a hand of at least one user and a face module configured to be worn in an area at chest level or above for at least one user;
determining whether the hand module comes within a predefined range of the face module come within a predefined range; and
generating an alert when the hand module comes within the predefined range of the face module.

11. An apparatus for encouraging prevention of hand-to-face contact, the apparatus comprising:
a memory; and
a processor configured to:
receive information from at least one of a hand module configured to be worn on a hand of at least one user and a face module configured to be worn in an area at chest level or above for at least one user;
determine whether the hand module comes within a predefined range of the face module; and
generate an alert when the hand module comes within the predefined range of the face module.

12. An apparatus for encouraging prevention of hand-to-face contact, the apparatus comprising:
means for receiving information from at least one of a hand module configured to be worn near a hand of at least one user and a face module configured to be worn in an area at chest level or above for at least one user;
means for determining whether the hand module comes within a predefined range of the face module; and
means for generating an alert when the hand module comes within the predefined range of the face module.

13. A computer-readable medium storing computer-executable code for encouraging preventing hand-to-face contact, comprising code for:
receiving information from at least one of a hand module configured to be worn near a hand of at least one user and a face module configured to be worn in an area at chest level or above for at least one user;
determining whether the hand module comes within a predefined range of the face module; and
generating an alert when the hand module comes within the predefined range of the face module.
